(19) United States
(12) Patent Application Publication
(10) Pub. No.: US 2006/0161691 A1
(43) Pub. Date: Jul. 20, 2006

(54) Methods and systems for synchronous execution of commands across a communication link

(76) Inventors: Behnam Katibian, Irvine, CA (US); George Alan Wiley, San Diego, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/285,400

(22) Filed: Nov. 23, 2005

Related U.S. Application Data
(60) Provisional application No. 60/630,853, filed on Nov. 24, 2004.
(60) Provisional application No. 60/631,549, filed on Nov. 30, 2004.
(60) Provisional application No. 60/632,825, filed on Dec. 2, 2004.
(60) Provisional application No. 60/633,071, filed on Dec. 2, 2004.
(60) Provisional application No. 60/633,084, filed on Dec. 2, 2004.
(60) Provisional application No. 60/632,852, filed on Dec. 2, 2004.

(51) Int. Cl. G06F 3/00

(52) U.S. Cl. 710/5

(57) ABSTRACT

A method for synchronously executing a plurality of commands generated by a first module and executed at a second module, wherein the first and second modules communicate through a communication link, is provided. The method includes generating the commands at the first module, transmitting the commands through the link to the second module, and associating the execution time of the commands with an independent event at the second module. When the independent event is detected, the commands are executed synchronously at the second module. The method can be specifically applied to a baseband processor controlling a camera through a camera interface module, wherein the processor and the camera interface module are connected through an MDDI link. An example of a baseband processor controlling a camera through a Pathfinder camera module interface module is described. Specific built-in mechanisms of the camera module interface that enable flexible implementation of the method are also provided.

### CROSS REFERENCE TO RELATED APPLICATIONS

The present application claims priority to Provisional Application No. 60/630,853 entitled “MDDI Host Core Design” filed Nov. 24, 2004, Provisional Application No. 60/631,549 entitled “Mobile Display Digital Interface Host Camera Interface Device” filed Nov. 30, 2004, Provisional Application No. 60/632,825 entitled “Camera MDDI Host Device” filed Dec. 2, 2004, Provisional Application No. 60/633,071 entitled “MDDI Overview” filed Dec. 2, 2004, Provisional Application No. 60/633,084 entitled “MDDI Host Core Pad Design” filed Dec. 2, 2004, and Provisional Application No. 60/632,852 entitled “Implementation of the MDDI Host Controller” filed Dec. 2, 2004, and assigned to the assignee hereof and hereby expressly incorporated by reference herein in their entirety.

The present application is also related to commonly assigned U.S. Pat. No. 6,760,772 B2, titled “Generating and Implementing a Communication Protocol and Interface for High Speed Data Transfer”, issued Jul. 6, 2004, the disclosure of which is incorporated herein by reference.

### BACKGROUND

1. Field of the Invention

The present invention relates generally to methods and systems for synchronous execution of commands across a communication link. More particularly, the invention relates to methods and systems for synchronously executing commands across a Mobile Display Digital Interface (MDDI) link.

2. Background of the Invention

In the field of interconnect technologies, demand for ever increasing data rates, especially as related to video presentations, continues to grow.

The Mobile Display Digital Interface (MDDI) is a cost-effective, low power consumption, transfer mechanism that enables very-high-speed data transfer over a short-range communication link between a host and a client. MDDI requires a minimum of just four wires plus power for bi-directional data transfer that delivers a maximum bandwidth of up to 3.2 Gbits per second.

In one application, MDDI increases reliability and decreases power consumption in clamshell phones by significantly reducing the number of wires that run across a handset's hinge to interconnect the digital baseband controller with an LCD display and/or a camera. This reduction of wires also allows handset manufacturers to lower development costs by simplifying clamshell or sliding handset designs.

Typical MDDI interconnections include MDDI controllers connected through an MDDI link, with one controller being the MDDI link host and the other controller being the MDDI link client. In linking a baseband processor to a device, such as a camera module, an interface is also generally used to relay commands from the processor to the device. Pathfinder, for example, is a device interface developed by Qualcomm Incorporated having an integrated MDDI host core that can be used to interface a baseband processor (with an MDDI client core) and a device, such as a camera, through MDDI.

Commands sent by a baseband processor through MDDI generally require no synchronization. However, in controlling a camera, for example, certain commands by the baseband processor require precise synchronous execution at the camera. For example, flash synchronization is required for the firing of the flash to exactly coincide with the opening of the camera shutter. Typically however, messages sent by the baseband processor through the MDDI link incur delays that depend on the usage of the link, and which cannot be accurately estimated. Accordingly, synchronizing the commands at the processor while attempting to compensate for the delays through the link is not a dependable solution for achieving synchronization at the camera.

What is needed therefore are methods and systems to synchronize the execution of commands transmitted by a baseband processor to a device, such as a camera, through MDDI.

### SUMMARY

The present invention relates generally to methods and systems for synchronous execution of commands across a communication link. More particularly, the invention relates to methods and systems for synchronously executing commands across a Mobile Display Digital Interface (MDDI) link.

In one aspect, a method for synchronously executing a plurality of commands generated by a first module and executed at a second module, wherein the first and second modules communicate through a communication link, is provided. The method includes generating the commands at the first module, transmitting the commands through the link to the second module, and associating the execution time of the commands with an independent event at the second module. When the independent event is detected, the commands are executed synchronously at the second module.

In another aspect, the method described above can be specifically applied to the case of a baseband processor controlling a camera through a camera module interface, wherein the baseband processor and the camera module interface are connected through an MDDI link. An example of a baseband Mobile Station Modem (MSM) processor controlling a camera through a Pathfinder camera module interface is described. Specific built-in mechanisms within the camera module interface that enable flexible implementation of the above described method are also provided.

Further embodiments, features, and advantages of the present invention, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram that illustrates an example environment using a Mobile Display Digital Interface (MDDI) interface.

FIG. 1A is a diagram of a digital data device interface coupled to a digital device and a peripheral device.

FIG. 2 is a block diagram that illustrates an MDDI link interconnection according to the example of FIG. 1 using a camera module interface.

FIG. 3 is a block diagram that illustrates an interconnection between a camera module interface and a camera module.

FIG. 4 is a process flowchart that illustrates a method for synchronously executing commands across a communication link.

FIG. 5 is a process flowchart that illustrates a method for performing synchronous execution of shutter and flash commands in a camera being controlled through a communication link.

FIG. 6 illustrates an example of flash synchronization.

The present invention will be described with reference to the accompanying drawings. The drawing in which an element first appears is typically indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Mobile Display Digital Interface (MDDI)

The Mobile Display Digital Interface (MDDI) is a cost-effective, low power consumption, transfer mechanism that enables very-high-speed serial data transfer over a short-range communication link between a host and a client.

In the following, examples of MDDI will be presented with respect to a camera module contained in an upper clamshell of a mobile phone. However, it would be apparent to persons skilled in the relevant art(s) that any module having functionally equivalent features to the camera module could be readily substituted and used in embodiments of this invention.

Further, according to embodiments of the invention, an MDDI host may comprise one of several types of devices that can benefit from using the present invention. For example, the host could be a portable computer in the form of a handheld, laptop, or similar mobile computing device. It could also be a Personal Data Assistant (PDA), a paging device, or one of many wireless telephones or modems. Alternatively, the host could be a portable entertainment or presentation device such as a portable DVD or CD player, or a game playing device. Furthermore, the host can reside as a host device or control element in a variety of other widely used or planned commercial products for which a high speed communication link is desired with a client. For example, a host could be used to transfer data at high rates from a video recording device to a storage based client for improved response, or to a high resolution larger screen for presentations. An appliance such as a refrigerator that incorporates an onboard inventory or computing system and/or Bluetooth connections to other household devices, can have improved display capabilities when operating in an internet or Bluetooth connected mode, or have reduced wiring needs for in-the-door displays (a client) and keypads or scanners (client) while the electronic computer or control systems (host) reside elsewhere in the cabinet. In general, those skilled in the art will appreciate the wide variety of modem electronic devices and appliances that may benefit from the use of this interface, as well as the ability to retrofit older devices with higher data rate transport of information utilizing limited numbers of conductors available in either newly added or existing connectors or cables. At the same time, an MDDI client may comprise a variety of devices useful for presenting information to an end user, or presenting information from a user to the host. For example, a micro-display incorporated in goggles or glasses, a projection device built into a hat or helmet, a small screen or even holographic element built into a vehicle, such as in a window or windshield, or various speaker, headphone, or sound systems for presenting high quality sound or music. Other presentation devices include projectors or projection devices used to present information for meetings, or for movies and television images. Another example would be the use of touch pads or sensitive devices, voice recognition input devices, security scanners, and so forth that may be called upon to transfer a significant amount of information from a device or system user with little actual “input” other than touch or sound from the user. In addition, docking stations for computers and car kits or desk-top kits and holders for wireless telephones may act as interface devices to end users or to other devices and equipment, and employ either clients (output or input devices such as mice) or hosts to assist in the transfer of data, especially where high speed networks are involved. However, those skilled in the art will readily recognize that the present invention is not limited to these devices, there being many other devices on the market, and proposed for use, that are intended to provide end users with high quality images and sound, either in terms of storage and transport or in terms of presentation at playback. The present invention is useful in increasing the data throughput between various elements or devices to accommodate the high data rates needed for realizing the desired user experience.

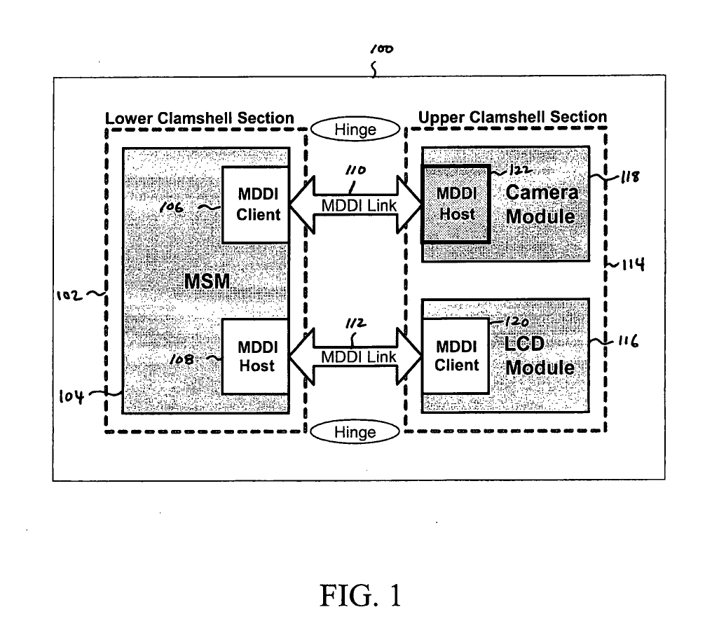

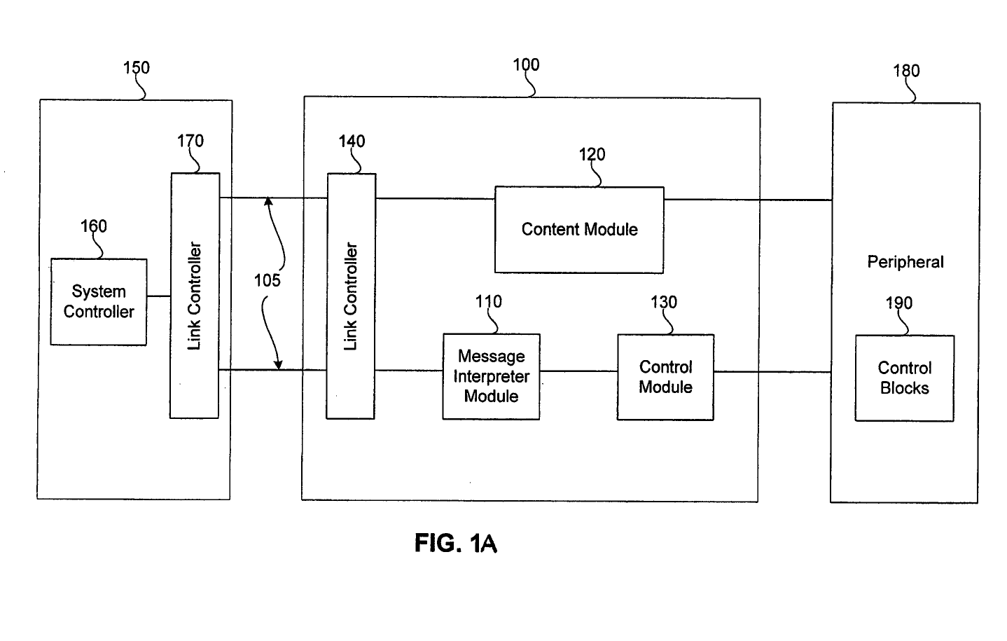

FIG. 1A is a diagram of a digital data device interface 100 coupled to a digital device 150 and a peripheral device 180. Digital device 150 can include, but is not limited to, a cellular telephone, a personal data assistant, a smart phone or a personal computer. In general digital device 150 can include any type of digital device that serves as a processing unit for digital instructions and the processing of digital presentation data. Digital device 150 includes a system controller 160 and a link controller 170.

Peripheral device 180 can include, but is not limited to, a camera, a bar code reader, an image scanner, an audio device, and a sensor. In general peripheral 180 can include any type of audio, video or image capture and display device in which digital presentation data is exchanged between a peripheral and a processing unit. Peripheral 180 includes control blocks 190. When peripheral 180 is a camera, for example, control blocks 190 can include, but are not limited to lens control, flash or white LED control and shutter control. Digital presentation data can include digital data representing audio, image and multimedia data.

Digital data interface device 100 transfers digital presentation data at a high rate over a communication link 105. In one example, an MDDI communication link can be used which supports bi-directional data transfer with a maximum bandwidth of 3.2 Gbits per second. Other high rates of data transfer that are higher or lower than this example rate can be supported depending on the communications link. Digital data interface device 100 includes a message interpreter module 110, a content module 120, a control module 130 and a link controller 140.

Link controller 140, which is located within digital data interface 100, and link controller 170, which is located within digital device 150 establish communication link 105. Link controller 140 and link controller 170 may be MDDI link controllers.

The Video Electronics Standards Association (“VESA”) MDDI Standard, which is incorporated herein by reference in its entirety, describes the requirements of a high-speed digital packet interface that lets portable devices transport digital images from small portable devices to larger external displays. MDDI applies a miniature connector system and thin flexible cable ideal for linking portable computing, communications and entertainment devices to emerging products such as wearable micro displays. It also includes information on how to simplify connections between host processors and a display device, in order to reduce the cost and increase the reliability of these connections. Link controllers 140 and 170 establish communication path 105 based on the VESA MDDI Standard.

U.S. Pat. No. 6,760,772, entitled Generating and Implementing a Communication Protocol and Interface for High Data Rate Signal Transfer, issued to Zou et al. on Jul. 6, 2004 ('772 Patent”) describes a data interface for transferring digital data between a host and a client over a communication path using packet structures linked together to form a communication protocol for presentation data. Embodiments of the invention taught in the '772 Patent are directed to an MDDI interface. The signal protocol is used by link controllers, such as link controllers 140 and 170, configured to generate, transmit, and receive packets forming the communications protocol, and to form digital data into one or more types of data packets, with at least one residing in the host device and being coupled to the client through a communications path, such as communications path 105.

The interface provides a cost-effective, low power, bi-directional, high-speed data transfer mechanism over a short-range “serial” type data link, which lends itself to implementation with miniature connectors and thin flexible cables. An embodiment of link controllers 140 and 170 establishes communication path 105 based on the teachings of the '772 Patent. The '772 Patent is herein incorporated by reference in its entirety.

In other embodiments, link controllers 140 and 170 can both be a USB link controller or they both can include a combination of controllers, such as for example, an MDDI link controller and another type of link controller, such as, for example, a USB link controller. Alternatively, link controllers 140 and 170 can include a combination of controllers, such as an MDDI link controller and a single link for exchanging acknowledgement messages between digital data interface device 100 and digital device 150. Link controllers 140 and 170 additionally can support other types of interfaces, such as an Ethernet or RS-232 serial port interface. Additional interfaces can be supported as will be known by individuals skilled in the relevant arts based on the teachings herein.

Within digital data interface device 100, message interpreter module 110 receives commands from and generates response messages through communication link 105 to system controller 160, interprets the command messages, and routes the information content of the commands to an appropriate module within digital data interface device 100.

Content module 120 receives data from peripheral device 180, stores the data and transfers the data to system controller 160 through communication link 105.

Control module 130 receives information from message interpreter 130, and routes information to control blocks 190 of peripheral device 180. Control module 130 can also receive information from control blocks 190 and routes the information to the message interpreter module 110.

FIG. 1 is a block diagram that illustrates an example environment using an MDDI interface. In the example of FIG. 1, MDDI is used to interconnect modules across the hinge of a clamshell phone 100. A lower clamshell section 102 of clamshell phone 100 includes a Mobile Station Modem (MSM) baseband chip 104. MSM 104 is a digital baseband processor. An upper clamshell section 114 of clamshell phone 100 includes a Liquid Crystal Display (LCD) module 116 and a camera module interface 118.

Still referring to FIG. 1, an MDDI link 110 connects camera module interface 118 to MSM 104. Typically, an MDDI link controller is integrated into each of camera module interface 118 and MSM 104. In the example of FIG. 1, an MDDI Host controller 122 is integrated into camera module interface 118, while an MDDI Client controller 106 resides on the MSM side of the MDDI link 110. Typically, the MDDI host is the master controller of the MDDI link. In the example of FIG. 1, pixel data from camera module interface 118 are received and formatted into MDDI packets by MDDI Host controller 122 before being transmitted onto MDDI link 110. MDDI client controller 106 receives the MDDI packets and re-converts them into pixel data of the same format as generated by camera module 118. The pixel data are then sent to an appropriate block in MSM 104 for processing.

An MDDI link 112 connects LCD module 116 to MSM 104. In the example of FIG. 1, MDDI link 112 interconnects an MDDI Host controller 108, integrated into MSM 104, and an MDDI Client controller 120 integrated into LCD module 116. In the example of FIG. 1, image data generated by a graphics controller of MSM 104 are received and formatted into MDDI packets by MDDI Host controller 108 before being transmitted onto MDDI link 112. MDDI client controller 120 receives the MDDI packets and re-converts them into image data for use by LCD module 116. Typically, image data is buffered using a frame buffer before being used to refresh the LCD display.

MSM to Camera Module Interface Communication

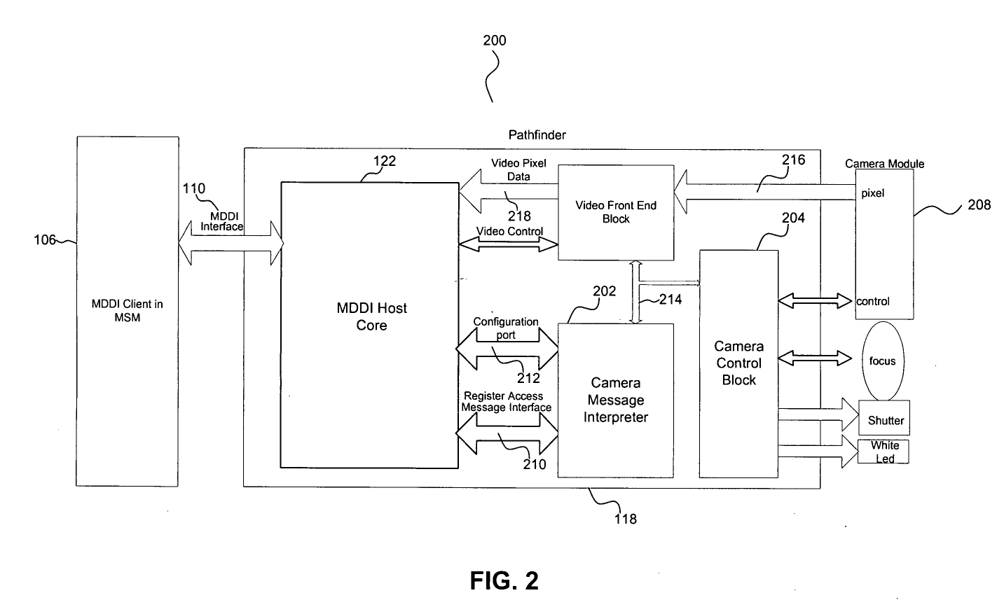

FIG. 2 is a block diagram that illustrates an MDDI link interconnection 200 according to the example of FIG. 1. MDDI link interconnection 200 includes an MDDI client 106, integrated in a baseband MSM processor, and an MDDI host 122, integrated in a camera module interface 118, connected through an MDDI link 110.

A camera module 208 is connected through one or more interfaces to camera module interface 118. Camera module interface 118, thus, provides an interface between the baseband MSM processor and the camera module. For example, camera module interface 118 may be a Pathfinder camera interface developed by Qualcomm Incorporated.

Camera module interface 118 includes, in addition to MDDI host core 122, a camera message interpreter 202, a camera control block 204, and a video front end block 206. Several interfaces and data buses connect the various blocks of the camera module interface as shown in FIG. 2.

Camera message interpreter (CMI) 202 receives data and control signals embedded into reverse Register Access Packets from the MSM through a Register Access Message Interface 210. CMI 202 decodes the received signals from the MSM, and executes the corresponding commands (register write or register read) using configuration interfaces 212 and 214 to MDDI host 122 or camera control block 204. Further, CMI 202 returns acknowledgments (for register write commands) or register values (for register read commands) through the Register Access Message Interface 210 to MDDI host core 122, which relays them to the MSM.

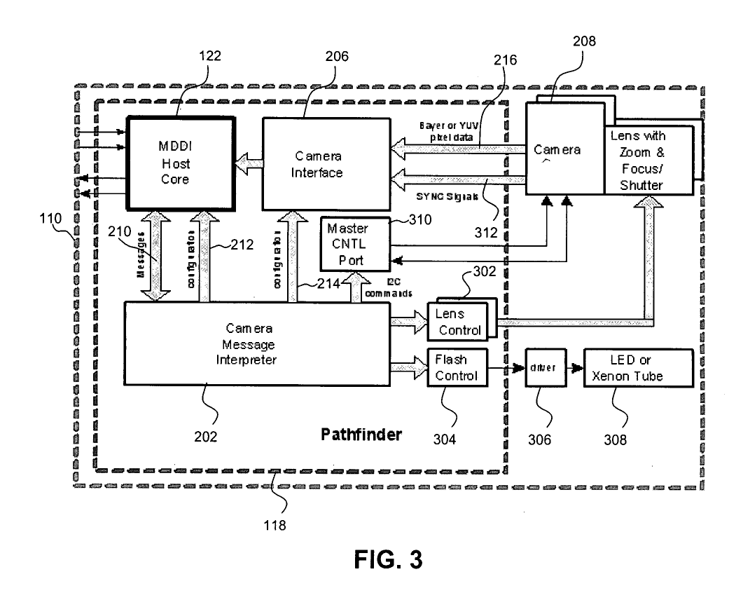

Camera control block (CCB) 204 provides access to camera registers to execute commands received at CMI 202. CCB 204 contains several submodules (not shown in FIG. 2), which include a control register block, a master control port block, a lens control block, a shutter control block, and a flash control block. The control register block contains registers for the lens control, shutter control, and flash control blocks. The master control port block provides an interface between CMI 202 and the camera 208. The lens control, shutter control, and flash control blocks serve as focus, shutter, and flash controllers of the camera module. The camera control block of the camera module interface will be further described below with reference to FIG. 3.

Video front end (VFE) block 206 receives frames from the camera 208 through a parallel interface 216, stores the frames, and then transfers the frames to the MDDI host core 122 through a frame interface 218.

As described above, communication between the MSM processor and the camera module interface 118 is done through MDDI link 110. Commands from the MSM to the camera module interface are typically encapsulated in MDDI packets at MDDI client 106, and de-encapsulated at MDDI host 122. Commands from the MSM to the camera module interface include, for example, MDDI host configuration commands, camera register access commands, and camera control commands. CMI 202 decodes commands received from the MSM based on a command ID field in the command header. The command ID also represents the value of the register base address for the register block associated with the command. Table 1 below shows some of the MSM command types received by the camera module interface:

TABLE 1

| Command ID | Description |
|---|---|
| 0x00 | MDDI host device configuration command |
| 0x40 | Camera Interface Control command |
| 0x60 | Lens control command |
| 0x80 | I2C command |
| 0x90 | Shutter control command |
| 0xA0 | White LED control command |
| 0xB0 | Three-wire serial interface control command |
| 0xC0 | PLL” control command |
| 0xD0-0xFF | Reserved commands |

Typically, an MSM command is 12 bytes long, and may include up to 7 bytes of register values to be written starting at a register address specified in the command. Tables 2 and 3 below show the content of shutter and flash control commands. As shown in Table 2, the shutter control command includes, for example, bytes for opening/closing the shutter, controlling the speed of the shutter, or controlling the timing of shutter operations. Similarly, the flash control command, shown in Table 3, includes, for example, bytes for controlling the intensity of the flash, the duration of the flash, or the number of pulses in a flash.

Generally, commands sent by the MSM processor require no synchronization. Certain commands, however, require precise synchronous execution at the camera as will be further discussed below.

TABLE 2
Shutter Control Command

| | Name | # of bits | Description |
|---|---|---|---|
| Byte 0 | TID | 8 | Transaction ID assigned by MSM |
| Byte 1 | Count | 8 | Total number of bytes in this message |
| Byte 2 | Command ID | 8 | Mechanical Shutter Command ID |
| Byte 3 | Read/write/status | 8 | Bit 0 - Read/Write, 0 write, 1 read |
| | byte | | Bit 1 - Ack Req, 0 no-req 1 req |
| | | | Bit 2 - Ack Status, 0 fail/error, 1 pass/success |
| | | | Bits 3-7 - reserved |
| Byte 4 | Shutter VSYNC | 8 | 8 bit value, number of VSYNC pulses prior to |
| | Count | | Shutter open command executed |
| Byte 5 | Shutter speed_high | 8 | Shutter speed, high byte |
| Byte 6 | Shutter speed_Low | 8 | Shutter speed, Low byte |
| Byte 7 | Shutter open/close | 1 | 0 - Shutter Open |
| | | | 1 - Shutter Close |
| Byte 6-11 | Reserved | 8 | |

TABLE 3
White LED/Flash Control Command

| | | # of | |
|---|---|---|---|
| | Name | bits | Description |
| Byte 0 | TID | 8 | Transaction ID assigned by MSM |
| Byte 1 | Count | 8 | Total number of bytes in this message |
| Byte 2 | Command ID | 8 | White LED control Command ID |
| Byte 3 | Read/Write/Status byte | 8 | Bit0 —Read/Write: 0 write, 1 read |
| | | | Bit1 —Ack Req: 0 no-req 1 req |
| | | | Bit2 —Ack Status: 0 fail/error, 1 pass/success |
| | | | Bits3-7 —reserved |
| | White LED Intensity | 8 | 0x00: 20 mA |
| | | | 0x01: 40 mA |
| | | | 0x02: 60 mA |
| | | | 0x03: 80 mA |
| | | | 0x04: 100 mA |
| | | | ... |
| | | | 0x09: 200 mA |
| | | | ... |
| | | | 0x0E: 300 mA |
| | | | 0x13: 400 mA |
| | | | 0x18: 500 mA |
| | | | 0x19-0xFF Reserved |
| Byte 4 | Red_Eye_Reduction_Mode_Pulses | 8 | Number of Red-Eye-Reduction pulses prior to full |
| | | | discharge pulse. This parameter should be set to |
| | | | 0x01 for full discharge pulse |
| Byte 5 | Pulse Duration | 8 | Duration of flash/strobe pulses in HCLK units |
| Byte 6 | White LED Duration | 8 | 0x00: No change; The state of the LED does not |
| | | | change. |
| | | | 0x01: LED on for 1 frame time |
| | | | ... |
| | | | 0xFF: LED on for 256 frame times |
| Byte 7 | Red_Eye_Reduction | 8 | Interval between Red_Eye_Reduction pulses, in |
| | Pulse Interval | | HCLK units |
| Byte 8 | White LED ON | 8 | 0x00: White LED OFF |
| | | | 0x01 = White LED ON |
| | | | 0x02 = Flash/Strobe Full Discharge |
| | | | 0x04 = Flash/Strobe Red Eye Reduction |
| Byte 9-11 | Reserved | 8 | |

As described above, the camera module interface serves as an interface between the MSM processor and the camera module. The CMI 202 component of camera module interface interprets commands received from the MSM, and executes these commands by writing or reading specific control registers in the camera module interface.

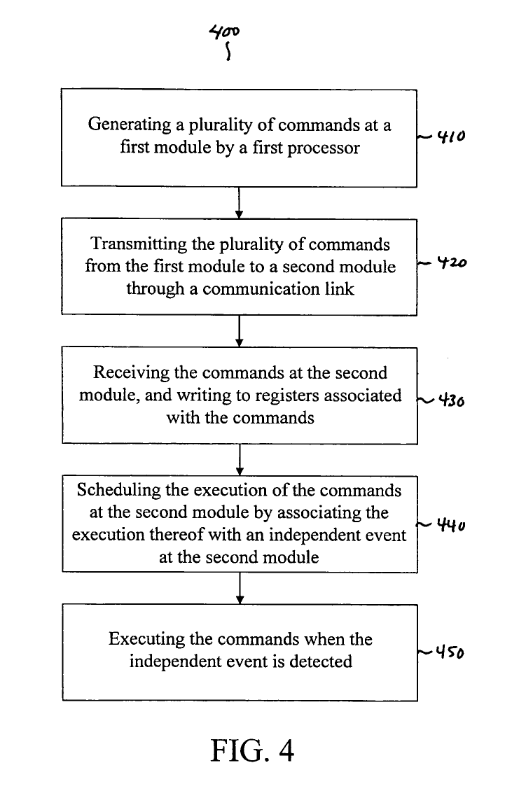

FIG. 3 is a block diagram that highlights the interconnection of camera module interface 118 with the camera module. In FIG. 3, the camera control block 204 of FIG. 4 is illustrated by some of its individual components—lens control, flash control, and master control port blocks 302, 304, and 314. Other components of camera control block 202 may have been omitted.

Lens control block 302 serves to control the zoom, focus, and shutter control mechanisms of the camera. Lens control block 302 provides a set of enable signals to an external motor driver to move the lens and open/close the shutter, for example. Alternatively, a separate shutter control block may be implemented together with a separate shutter control driver. Lens and shutter control blocks respond to values of corresponding control registers of the CCB 204. Table 4 below illustrates lens control registers associated with controlling the shutter of the camera. Typically, a mechanical shutter driver responds to values of the registers. For example, as shown in Table 4, an 8 bit register at location 0×90 controls the specific time when a shutter open command is executed. An 8 bit register at location 0×93 controls whether the shutter should be opened or closed.

Flash control block 304 serves to control a white LED/Flash of the camera. As shown in FIG. 3, flash control block 304 communicates with a driver 306 to control a LED or Xenon Tube 308. Typically, flash control block 304 provides a

TABLE 4
Shutter control registers

| Lens | | |
|---|---|---|
| control | | |
| registers | Description | Bit field |
| 0x90 | Shutter “Wait” period | 8 bit value, number of VSYNC pulses |
| | | prior to Shutter open command |
| | | executed |
| 0x91 | Shutter speed - High | 8 bits |
| | Byte | |
| 0x92 | Shutter speed - Low | 8 bits, 1 ms granularity |
| | Byte | |
| 0x93 | Shutter open/close | 0 = shutter open |
| | | 1 = shutter close |

set of enable signals to driver 306 to control the flash operations. Similar to the shutter control block, the flash control block responds to the settings of corresponding flash control registers. Table 5 below illustrates registers associated with controlling the flash of the camera. Flash control registers include, for example, registers for specifying the flash current intensity, the flash duration, or the pulse interval between pulses in a red eye reduction flash mode.

TABLE 5
Flash control registers

| White LED | | |
|---|---|---|
| control | | |
| registers | Description | Bit field |
| 0xA0 | LED current intensity | 8 bits |
| | | 00h = 20 mA |
| | | 01h = 40 mA |
| | | ... |
| | | 14h = 400 mA |
| | | 15h-2Fh = reserved |
| 0xA1 | Red_Eye_Reduction_Mode_Pulses | 8 bits |
| | | Number of Red-Eye-Reduction pulses prior |
| | | to full discharge pulse |
| | | This parameter should be set to 0x01 for |
| | | full discharge pulse |
| 0xA2 | Pulse Duration | 8 bits |
| | | Duration of flash/strobe pulses in HCLK |
| | | units |
| 0xA3 | White_LED_Pulse_Duration | 8 bits |
| | | Duration of full discharge pulse, in video |
| | | frame units |
| | | 00h-1 Frame |
| | | 02h-FFh = increments of 1 frame time up |
| | | to 256 frames |
| 0xA4 | Red_Eye_Reduction Pulse Interval | 8 bits |
| | | Interval between Red_Eye_Reduction |
| | | pulses, in HCLK units |
| 0xA5 | LED ON/OFF register | 8 bits |
| | | 00h = White LED OFF |
| | | 01h = White LED ON |
| | | 02h = Flash/Strobe - Full discharge |
| | | 04h = Flash/Strobe - Red_Eye_Reduction |

Master control port block 310 provides access to registers of the camera 208. Master control port block 310 converts control data intended for the camera into the I2C protocol (used by most CMOS and CCD camera modules) or the three-wire serial interface protocol used by some CCD sensors. Typically, master control port block 310 reads values to be sent to the camera from corresponding I2C or three-wire control registers.

Note that FIG. 3 also shows a set of SYNC signals 312 being sent from the camera 208 to the camera interface block 206. SYNC signals 312 are typically associated with certain events at the camera, and may be used as timing signals to synchronize camera module interface 118 and camera module 208.

Synchronous Execution of Commands Across MDDI

As described above, certain MSM commands require precise synchronous execution at the camera module interface. However, since delays through the MDDI link cannot be accurately estimated or predicted, scheduling commands at the MSM in such a way as to have them execute synchronously at the camera module cannot be depended on for precise synchronization. Accordingly, command synchronization needs to be done at the camera module. Control mechanisms are, therefore, needed at the camera module to provide for synchronous execution of two or more camera commands.

Methods and systems for synchronous execution of commands across a communication link will now be provided. It is noted that in many aspects, while some of these methods and systems will be presented using specific MDDI and/or Pathfinder examples, these methods and systems can be extended to more general contexts as can be understood by persons skilled in the art(s) based on the teachings herein. Accordingly, methods and systems of the present invention are not limited to synchronizing commands across an MDDI link nor are they limited to the context of a baseband processor controlling a camera through a camera module interface.

FIG. 4 is a process flowchart 400 that illustrates a method for synchronously executing commands across a communication link. Process flowchart 400 begins in step 410, which includes generating a plurality of commands at a first module by a first processor. For example, referring to FIG. 1, step 410 may be achieved by baseband MSM processor 104 generating a plurality of camera control commands.

Step 420 includes transmitting the plurality of commands from the first module to a second module through a communication link. For example, referring to FIG. 1, step 420 may be achieved by baseband MSM processor 104 transmitting camera control commands to camera module interface 118 through MDDI link 110. Note that the commands are transmitted at random times that are typically independent from each other.

Step 430 includes receiving the commands at the second module, and writing to registers associated with the commands. For example, referring to FIG. 2, step 430 may be achieved by camera module interface 118 receiving commands from the MSM 104, and writing to specific control registers of the camera control block 204 that correspond to the received commands.

Step 440 includes scheduling the execution of the commands at the second module by associating the execution thereof with an independent event at the second module. For example, referring to FIG. 3, commands received at camera module interface 118 from the MSM processor are scheduled to be executed when a specific event occurs at the camera module interface. The event is independent of any of the commands being scheduled for execution. For example, the event may be indicated by one of the SYNC signals 312 received from camera 208, as shown in FIG. 3. Accordingly, one or more of the commands being scheduled for execution may be delayed at the second module.

Step 450 includes executing the commands when the independent event is detected at the second module. For example, the independent event may be detected through an interrupt that is triggered at the occurrence of the independent event. Note that the plurality of commands execute synchronously since their execution times have been associated with the same event. Accordingly, precise synchronous execution of a plurality of commands can be achieved across the communication link.

It is noted that the method described in FIG. 4 is generally applicable to any application that requires precise synchronous execution of multiple commands across a communication link. Specifically, the method can be applied in the context of MSM to camera module interface communication as will be further described below. For example, the method may be used to synchronously execute camera commands generated by the MSM at the camera module interface. These commands may include commands related to flash synchronization, for example, such as flash and shutter commands. Methods and systems to describe the specific application of the method of FIG. 4 to MSM to camera module interface communication will now be provided. The methods and systems will be presented in the context of flash synchronization (shutter and flash synchronization) for purposes of illustration only, and should not be limited to this specific example as can be understood by a person skilled in the art(s) based on the teachings herein.

The camera module interface includes built-in mechanisms and signals that allow for the method of FIG. 4 to be implemented in a very flexible manner. These mechanisms and signals will now be described in more detail. A method for using these mechanisms and signals to achieve synchronous execution of multiple commands in the camera module interface will then be provided.

One available mechanism includes EPOCH (relative to an epoch reference time of the system) interrupts that can be enabled using the camera interface block of the camera module interface. EPOCH interrupts can be scheduled to trigger the execution of commands received by the camera message interpreter block of camera module interface. Accordingly, EPOCH interrupts can be associated with multiple MSM commands to trigger the execution of these commands simultaneously.

Further, EPOCH interrupts can be programmed to trigger the execution of MSM commands based on specific signals within the camera module interface. For example, EPOCH interrupts can trigger the execution of MSM commands when specific values are received on the SYNC signals received from the camera. SYNC signals, shown in FIG. 3, may include camera frame buffer timing signals, such as line or frame synchronization signals. A line synchronization signal, HSYNC, for example, indicates the start of a line of data in the frame buffer. A frame synchronization signal, VSYNC, indicates the start of a new frame in the frame buffer. Accordingly, MSM commands can be designed to execute synchronously at specific times in the frame buffer. In the example of flash synchronization, this allows for having both frame exposure type sensors or rolling shutter exposure type sensors. In other words, flash synchronization can be done over one or more entire frames or over only a few lines of the frames.

MSM commands, further, include built-in properties that allow for very flexible execution scheduling. For example, certain MSM commands include programmable fields of desired execution time, which may be programmed to occur at specific periods of time following the occurrence of certain events within the camera module interface. For example, the shutter control command, shown in Table 2, includes a programmable field (Byte 4) to specify the number of VSYNC pulses that need to elapse between the time the command is received at the camera module interface and the time that it is executed. Similar programmable fields are also found in other MSM command to allow for very flexible scheduling of these commands.

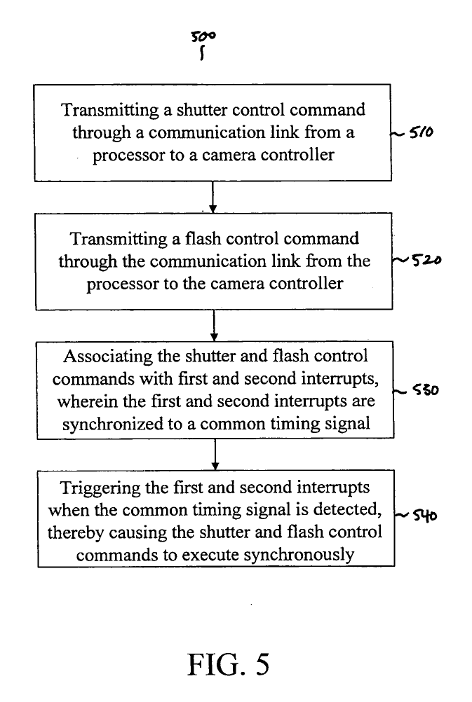

Accordingly, using the built-in mechanisms and signals of camera module interface, multiple MSM commands can be scheduled to execute synchronously at the camera. FIG. 5 illustrates a process flowchart 500 that describes a method for synchronously executing multiple MSM commands using the camera module interface. The method of FIG. 5 is described, for purposes of illustration only, in the context of flash synchronization, but should not be limited to that specific example as is apparent to a person skilled in the art(s) based on the teachings herein.

Process flowchart 500 begins in step 510, which includes transmitting a shutter control command through a communication link from a processor to a camera controller. Referring to FIG. 2, for example, step 510 may be achieved by the MSM processor sending a shutter open command through MDDI link 110 to camera module interface 118. The shutter open command includes a desired execution time specified in terms of VSYNC pulses that need to elapse before the command is executed.

Step 520 includes transmitting a flash control command through the communication link from the processor to the camera controller. Referring to FIG. 2, for example, step 520 may be achieved by the MSM processor sending a white LED command through MDDI link 110 to camera module interface 118. The white LED command may include information regarding the flash duration and the operation mode (torch mode or flash mode) as shown in Table 3. Depending on the operation mode, the command will be enabled for a number of frames or will be more tightly coupled to the camera sensors.

Step 530 includes associating the shutter and flash control commands with first and second interrupts, wherein the first and second interrupts are synchronized to a common timing signal. For example, referring to FIG. 3, shutter and flash control commands received by camera module interface 118 may be associated with EPOCH interrupts at camera interface block 206. The EPOCH interrupts may be further programmed to cause execution of the shutter and flash control commands when specific pulses are received from SYNC signals 312, such as line synchronization HSYNC and/or frame synchronization VSYNC pulses, for example.

Step 540 includes triggering the first and second interrupts when the common timing signal is detected, thereby causing the shutter and flash control commands to execute synchronously. For example, EPOCH interrupts associated with the shutter and flash control commands may be triggered when a start of frame (VSYNC) signal is received at the camera module interface causing the shutter and flash commands to execute simultaneously.

In a broader context, the method of FIG. 5 may be used to synchronize any number of camera control commands generated by the MSM to signals received from the camera. Consecutive execution of commands according to specific timing schedules may also be achieved using methods and systems substantially similar to the ones described above.

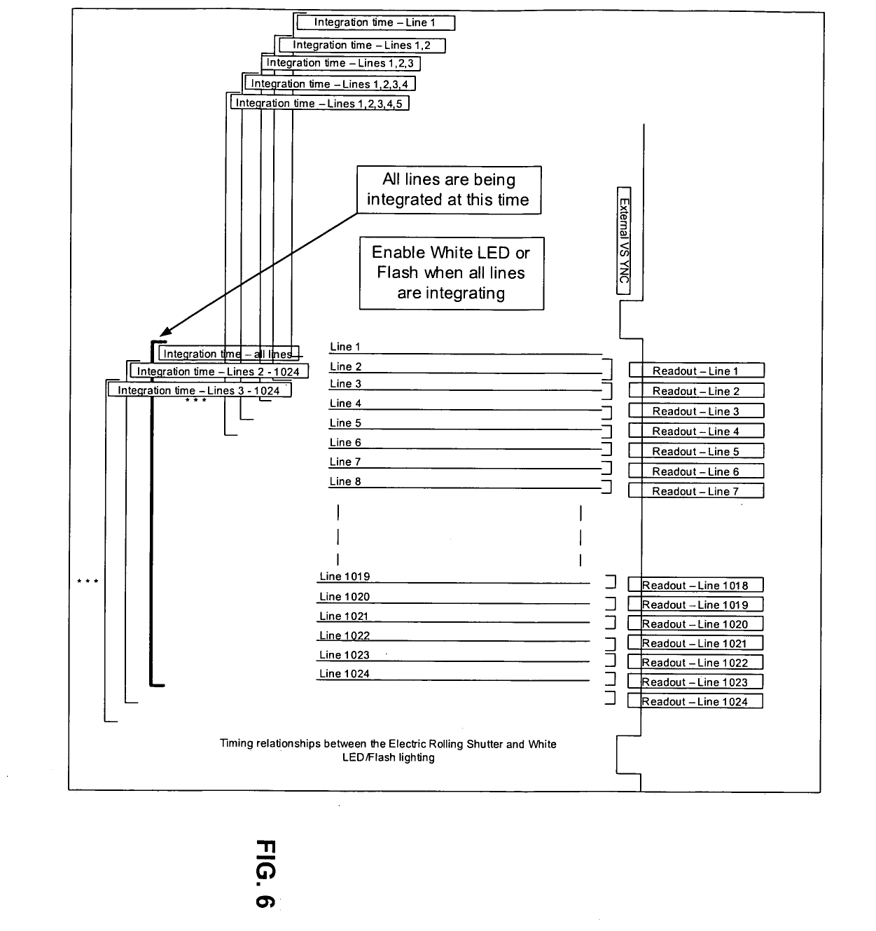

FIG. 6 illustrates an example of flash synchronization. More specifically, FIG. 6 shows an example synchronization between a rolling shutter and a white LED/Flash. It is desired in the example of FIG. 6 that the flash lighting occurs at the specific time instant when all lines of the frame are integrating. This may be the case, for example, for a frame exposure type sensors. The vertical axis on the left side of FIG. 6 shows the lines of the buffer that are integrating with the bracket in bold showing the desired integration time. On the right side, the vertical signal shows the frame synchronization signal VSYNC which indicates the start or end of a frame. Note that in a rolling shutter exposure type sensors, not all frame lines need to be integrating at the instant that the flash is applied. For example, only a few lines of the frame may be exposed at one time, and the camera builds a frame by reading out the most exposed lines, starting exposure at the next unexposed line, and repeating the process on the next most exposed line. As each fully exposed line is read out, another line is added to the set of rows being integrated.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for synchronously executing a plurality of commands generated by a first module and executed at a second module, wherein the first and second modules communicate through a communication link, the method comprising:
(a) generating the plurality of commands at the first module by a first processor;
(b) transmitting the plurality of commands from the first module to the second module through the communication link;
(c) receiving the commands at the second module, and writing to registers associated with the commands;
(d) scheduling the execution of the commands at the second module by associating the execution thereof with an independent event at the second module; and
(e) executing the commands when the independent event is detected.

2. The method of claim 1, wherein the communication link represents a Mobile Display Digital Interface (MDDI) link.

3. The method of claim 2, wherein the first module represents a baseband processor and the second module represents a camera module interface.

4. The method of claim 1, wherein the commands are transmitted through the communication link at random times that are independent from each other.

5. The method of claim 1, wherein one or more of the commands are delayed at the second module before execution.

6. The method of claim 1, wherein step (d) comprises associating the execution of the commands with an interrupt that indicates the occurrence of the independent event.

7. The method of claim 6, wherein the commands comprise a shutter control command and a flash control command that control a camera.

8. The method of claim 7, wherein the shutter and flash control commands execute at a time relative to a timing signal associated with the camera.

9. The method of claim 8, wherein the timing signal represents a frame synchronization signal of a frame buffer associated with the camera.

10. The method of claim 8, wherein the timing signal represents a line synchronization signal of a frame buffer associated with the camera.

11. A method for performing synchronized execution of shutter and flash commands in a camera, wherein the camera is controlled through a communication link by a processor, comprising:
(a) transmitting a shutter control command through the communication link from the processor to a camera controller associated with the camera;
(b) transmitting a flash control command through the communication link from the processor to the camera controller;
(c) associating the shutter and flash control commands with first and second interrupts at the camera controller, wherein the first and second interrupts are synchronized to a common timing signal at the camera controller; and
(d) triggering the first and second interrupts when the common timing signal is detected, thereby causing the shutter and flash control commands to execute synchronously.

12. The method of claim 11, wherein the communication link represents a Mobile Display Digital Interface (MDDI) link.

13. The method of claim 12, wherein the processor represents a Mobile Station Modem (MSM) baseband processor and the camera controller represents a Pathfinder camera controller.

14. The method of claim 11, wherein the shutter and flash control commands are transmitted at distinct times through the communication link, and wherein the times are independent from each other.

15. The method of claim 11, wherein the shutter control command represents a shutter open command, and the flash control command represents a flash lighting command.

16. The method of claim 15, wherein the shutter open and flash lighting commands execute synchronously relative to the timing signal.

17. The method of claim 15, wherein the timing signal represents a frame synchronization signal of a frame buffer associated with the camera.

18. The method of claim 15, wherein the timing signal represents a line synchronization signal of a frame buffer associated with the camera.

19. The method of claim 17, wherein the shutter open and flash lighting commands execute relative to the frame synchronization signal of the frame buffer to enable complete frame exposure of camera sensors.

20. The method of claim 18, wherein the shutter open and flash lighting commands execute relative to the line synchronization signal of the frame buffer to enable a rolling shutter exposure of camera sensors.
